(19) United States
(12) Patent Application Publication
(10) Pub. No.: US 2005/0136165 A1
(43) Pub. Date: Jun. 23, 2005

(54) Flavor and microbiologically stable food composition

(75) Inventors: Michael Charles Cirigliano, Cresskill, NJ (US); Domenic Caravetta, Congers, NY (US)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Unilever Bestfoods, North America

(21) Appl. No.: 10/744,747

(22) Filed: Dec. 23, 2003

(51) Int. Cl. A23L 1/22

(52) U.S. Cl. 426/534

(57) ABSTRACT

An improved flavor and microbiologically stable food composition is described. The food composition has low levels of humectant, a stabilizing salt, and little to no sodium chloride. The food composition is free of pathogenic and/or spoilage organism outgrowth for at least about thirty days.

### FIELD OF THE INVENTION

The present invention is directed to a microbiologically stable food composition having excellent flavor characteristics. The microbiologically stable food composition of this invention comprises less than about 5.0% by weight humectant, and a stabilizing salt whereby the food composition is unexpectedly free of pathogenic and/or spoilage organism outgrowth for at least about 30 days, even when the same is not thermally processed. Moreover, the food composition of this invention can be carbohydrate free, formulated substantially free of sodium chloride or with no sodium chloride, and have a water activity (A_{w}) of about 0.97 or less.

### BACKGROUND OF THE INVENTION

Many conventional food compositions have been marketed for use with food items like sandwiches, hot dogs, crackers, salads, vegetables and macaroni. Such conventional compositions are typically cold packed or processed, the former usually comminuted and mixed without emulsifying agents and the latter comprising emulsifying agents and cooked to pasteurization temperatures.

The drawbacks associated with such conventional compositions include the expense of the products, the need for carefully controlled refrigeration, the difficulty in packaging large quantities for food service applications, and the often required need for thermal processing which leads to products with inferior flavor characteristics.

There is increasing interest to develop a good tasting food composition that is stable at ambient temperature or at an extended shelf life chilled temperature, or both. This invention, therefore, is directed to a microbiologically stable food composition that comprises less than about 5.0% by weight humectant, and a stabilizing salt wherein the food composition is unexpectedly free of pathogenic and/or spoilage organism outgrowth for at least about 30 days, even when the food composition is not thermally processed. Preferably, the food composition of this invention is carbohydrate free, formulated with little to no sodium chloride, and has an A_{w} of about 0.97 or less.

Additional Information

Efforts have been disclosed for making edible compositions. In U.S. Patent Application No. 20030049357 A1, edible compositions with a gum and non-nutritive sweetener are described.

Other efforts have been disclosed for making savory products. In U.S. Patent Application No. 20020197354 A1, a bakeable savory cheese product is described.

Still other efforts have been disclosed for making savory products. In U.S. Application No. 20020155198 A1, a low moisture shelf-stable bakeable savory cheese product is described.

None of the additional information above describes a microbiologically stable food composition with less than about 5.0% by weight humectant, a stabilizing salt and an A_{w} of less than about 0.97.

### SUMMARY OF THE INVENTION

In a first aspect, the present invention is directed to a food composition comprising:
a) less than about 5.0% by weight humectant;
b) a stabilizing salt; and
c) water
   wherein the food composition has an A_{w} of less than about 0.97 and is microbiologically stable.

In a second aspect, the present invention is directed to a method for making the food composition of the first aspect of this invention.

Microbiologically stable means no outgrowth of pathogens like Salmonella typhimurium, and/or spoilage organisms like psychrophilic bacteria, lactobacilli, yeast and/or mold, for at least about thirty days at ambient temperature or at an extended shelf life chilled temperature (i.e., 4-7° C.), or both. Stabilizing salt means a salt suitable for food compositions, excluding sodium chloride. Water activity (A_{w}) means the ratio of the water vapor pressure in any kind of food system to the water vapor pressure of pure water. Thermally processed means heated to at least about 55° C., and substantially free of sodium chloride means less than about 5.5% by weight based on total weight of the food composition.

### DETAILED DESCRIPTION OF THE PREFERRED EMBODIMENTS

There is no limitation with respect to the type of food composition that comprises the humectant and stabilizing salt of this invention other than that the food composition can be formulated to be microbiologically stable as defined herein. Illustrative examples of the general types of food compositions suitable for use in this invention include mixtures, suspensions, and emulsions, including water-in-oil emulsions, oil-in-water emulsions, and double emulsions like water-in-oil-in-water emulsions. Such a food composition, therefore, can be a dip, sauce, spread, filling, spoonable dressing, pourable dressing, or the like.

The food composition of this invention typically comprises less than about 5.0% by weight humectant, and preferably, from about 0.25 to about 4.5%, and most preferably, from about 0.35 to about 3.5% by weight humectant, based on total weight of the food composition and including all ranges subsumed therein.

There is no limitation with respect to the type of humectant that may be used in this invention other than that the humectant is suitable for use in a food composition. Illustrative examples of the types of humectants that may be employed in this invention include, but are not limited to, propylene glycol, sorbitol, glycerol, mannitol, mixtures thereof or the like.

The stabilizing salt that may be used in this invention is limited only to the extent that the same can be used in a food composition. Illustrative examples of the stabilizing salts which may be used in this invention include, but are not limited to, inorganic salts such as calcium hydroxide, magnesium hydroxide, iron hydroxide, calcium oxide, magnesium oxide, iron oxide, calcium chloride, magnesium chloride, iron chloride, calcium carbonate, magnesium carbonate, iron carbonate, calcium nitrate magnesium nitrate, iron nitrate, calcium sulfate, magnesium sulfate, iron sulfate, calcium phosphate, magnesium phosphate, iron phosphate, sodium phosphate, sodium hexametaphosphate, ferric pyrophosphoric acid, dolomite, potassium sulfate, potassium chloride, potassium carbonate, potassium phosphate, sodium bisulfate, ammonium bisulfate, sodium tartarate, potassium acetate, sodium acetate, sodium lactate, mixtures thereof or the like.

Organic salts, like alkali metal salts of malic acid, succinic acid, citric acid, tartaric acid, acetic acid, lactic acid, adipic acid, fumaric acid and glutamic acid, may also be used as the stabilizing salt in the invention, either alone or as a mixture, including as a mixture with the inorganic salts identified above.

The amount of stabilizing salt employed in the food composition of this invention does not exceed about 5.5% minus the percent by weight of sodium chloride employed. Typically, therefore, the amount of sodium chloride employed plus the amount of stabilizing salt employed is no more than about 5.5% by weight, based on total weight of the food composition. Preferably, sodium chloride makes up from about 0.0% to about 3.5% by weight of the food composition and stabilizing salt makes up from about 0.5 to about 3.5% by weight of the food composition, including all ranges subsumed therein. In a most preferred embodiment, sodium chloride makes up from about 1.0% to about 2.5% by weight of the food composition and stabilizing salt makes up from about 0.2% to about 3.0% by weight of the food composition.

The amount of water employed in the food composition of this invention is limited only to the extent that a microbiologically stable food composition can be made. Typically, the food composition of the present invention comprises from about 22.0% to about 85.0%, and preferably, from about 40.0% to about 75.0%, and most preferably, from about 45.0% to about 60.0% by weight water, based on total weight of the food composition and including all ranges subsumed therein.

When the food composition of the present invention is an edible emulsion, the only limitation with respect to the type of oil used to make the edible emulsion is that the oil is suitable for human consumption. Illustrative examples of the types of oil which may be used in this invention include, without limitation, those which are liquid at ambient temperature like avocado, mustard, coconut, cottonseed, fish, flaxseed, grape, olive, palm, peanut, rapeseed, safflower, sesame, soybean, sunflower, oil mixtures thereof or the like.

Other types of oils which may be used in this invention are solid at ambient temperature. Illustrative examples of the oils which are solid at room temperature and suitable for use in this invention include, without limitation, butter fat, chocolate fat, chicken fat, coconut oil, hydrogenated palm kernel oil, mixtures thereof or the like.

When the food composition of the present invention is an emulsion, the desired emulsifier usually has an HLB of greater than about 8.0, and preferably, greater than about 11.0, and most preferably, from about 12.0 to about 18.0, including all ranges subsumed therein. Illustrative examples of such an emulsifier suitable for use in this invention include, without limitation, PEG 20 tristearate, PEG 20 trioleate, PEG 20 monostearate, PEG 20 monooleate, PEG 20 monopalmitate and PEG 20 monolaurate sorbitan, derivatives thereof, mixtures thereof or the like, as made available by ICI Surfactants under the names Tween or Span. An often preferred emulsifier employable in this invention is, however, a protein, like fruit, vegetable (e.g., pea protein), milk (e.g., whey) or soy protein, or mixtures thereof. Another preferred protein suitable for use in this invention is phospholipoprotein (e.g., phospholipoprotein present in egg yolk, whole egg or enzyme modified egg), and especially, egg yolk derived phospholipoprotein modified with phospholipase A as disclosed in U.S. Pat. No. 5,028,447, the disclosure of which is incorporated herein by reference.

It is noted that in lieu of or in combination with oil, conventional fat substitutes may be used in the food composition of this invention. Preferred fat substitutes employable in this invention include fatty acid-esterified alkoxylated glycerin compositions as well as sucrose fatty acid esters. The former and latter are described in U.S. Pat. Nos. 5,516,544 and 6,447,824, respectively, the disclosures of which are incorporated herein by reference. When employed, such conventional fat substitutes preferably make up at least about 30.0%, and most preferably, at least about 75.0% of the total weight of oil in the food composition.

If desired, food grade starches may be employed in the food composition of this invention whereby such starches can be modified, non-modified, instant or cook-up starches as well as mixtures of the same. Such starches (e.g., corn, waxy, maize, potato, rice, tapioca, wheat or mixtures thereof) are known thickening agents and often made commercially available from suppliers like National Starch and Chemical Company, Corn Products International and E.W. Staley Manufacturing Company. Cook-up starches are the generally preferred starches used in the edible emulsion of the present invention, with Snowflake cook-up starch from Corn Products International usually being most preferred. The amount of starch used in the food composition of this invention is typically from about 0.0% to about 4.0% by weight, based on total weight of the food composition and including all range subsumed therein.

Gums may be used along with or in lieu of starches. When desired, the gum used is often cellulose, locust bean, xanthan, carageenan, guar gum, mixtures thereof or the like. Such gums typically make up from about 0.0% to about 0.75% by weight of the total weight of the food composition, including all ranges subsumed therein.

It is particularly noted herein that if thermal processing, like pasteurization, is not desired (i.e., so that flavor/taste characteristics are maximized), the food composition described herein may be acidified in order to enhance the inhibition of microbiological growth. When acidified, the food composition typically has enough acidulant added so that the pH of the same is from about 2.75 to about 5.75, and preferably, from about 2.85 to about 5.50, and most preferably, from about 3.25 to about 4.25, including all ranges subsumed therein.

There is no limitation with respect to the type of acidulant employed in this invention other than that the acidulant is one which may be used in formulations suitable for human consumption. Illustrative examples of the types of acidulants which may be used in this invention include, without limitation, acetic acid, citric acid, hydrochloric acid, lactic acid, malic acid, phosphoric acid, glucono-delta-lactone, mixtures thereof and the like. In a preferred embodiment, the acidulant employed in this invention is citric acid, or a mixture of hydrochloric or phosphoric acid, and lactic acid, with lactic acid making up no more than about 40.0% by weight of the total weight of the acidulant mixture. It is noted that acidulant may be added before or after the food composition is made. In an especially preferred embodiment, however, acidulant is added after the food composition is made when the same is an emulsion.

The food composition of this invention may be combined with optional additives to make a most desired food composition ready for consumption. Preferred optional additives which may be employed in the food composition of the present invention include mustard flour, chocolate, nut paste, nutmeats, salt (and other spices and seasonings), vitamins, artificial flavors and colors (e.g., beta carotene), fruit puree, preservatives, antioxidants, chelators, meat like ham, chicken, fish, beef and bacon bits or particulates, buffering agents, vegetable bits or particulates, bread crumbs, fruit bits or particulates, cheese, mixtures thereof and the like. Such optional additives, when used, collectively, do not make up more than about 60.0% by weight of the total weight of the food product. Often, the most desired optional additive is real cheese, cheese powder, natural cheese flavor, artificial cheese flavor or a mixture thereof.

When preparing the composition, the optional additives may be added to water and/or oil in no particular order and stirred. Preferably, the optional additives are mixed in at the end of the manufacturing process if an emulsion is desired (especially when the optional additives are large, like fruit or bacon bits). In a preferred embodiment, the food composition of this invention, when an emulsion, comprises less than about 78.0%, and preferably, less than about 55.0%, and most preferably, from about 6.0 to about 35.0% by weight oil, based on total weight of the food composition and including all ranges subsumed therein. In an especially preferred embodiment, the food composition of this invention, when an emulsion, comprises from about 65.0% to less than 75.0% by weight oil, based on total weight of the food composition and including all ranges subsumed therein.

The preferred preservatives suitable for use in this invention include sodium benzoate, potassium benzoate, potassium sorbate, sorbic acid, benzoic acid, mixtures thereof or the like. Surprisingly, less than about 0.30% by weight of preservative is optionally needed in the food composition of this invention in order to achieve excellent microbiological stability. Typically, however, from about 0.025% to about 0.25% by weight of preservative is used, based on total weight of the food composition, including all ranges subsumed therein.

Anti-oxidants suitable for use in this invention include a tocopherol, ascorbic acid, ascorbyl palmitate, tertiary-butyl hydroquinone, tea-derived catechins, and mixtures thereof or the like. Chelators suitable for use in this invention include EDTA and its salts, phytic acid and its salts and/or esters, sodium hexametaphosphate, sodium tripolyphosphate, sodium carbonate, potassium carbonate, mixtures thereof or the like.

The fruit and vegetable bits that may be used in the food composition of this invention are preferably small enough to fit through the orifice present in a conventional squeeze bottle. The vegetable bits often include peppers, lettuce, carrots, cabbage, onion, broccoli, mixtures thereof or the like. The fruit bits often include pears, apples, grapes, tomatoes, mixtures thereof or the like.

It is particularly noted that solid components like fruits, vegetables, fish and meats added to the food compositions of this invention may optionally be pretreated with an aqueous marinating solution comprising humectant, acidulant, chelating agent, antioxidant and/or preservative as described herein.

The cheese (i.e., real or powder) suitable for use in this invention can be skim, part skim or full fat cheese. Typical non-limiting examples of the types of cheese (including processed cheese) suitable for use in this invention include gouda, edam, leyden, cheddar, goat, chesire, stilton, mozzarella, cream cheese, brie, feta, tilsit, mixtures thereof or the like. When cheese is employed to make the food composition, it is preferred that the same be melted prior to being added to any step in the manufacturing process. Often, the food composition will comprise from about 0.5% to about 75.0% by weight cheese, including all ranges subsumed therein.

Still other additives which may be optionally added to the food composition of this invention include protein sources and sweeteners. The former include caseinate and skimmed milk powder and the latter include syrups, sucrose, glucose, saccharin, aspartame, sucralose, dextrose, lactose, levelose, maltose, fructose, mixtures thereof or the like.

The viscosity of the food compositions of this invention is typically greater than about 3,000 and less than about 150,000 centipoise. When a sauce or pourable dressing is, for example, the desired food composition, the viscosity of the food composition is preferably from about 4,000 to about 10,000 centipoise, and most preferably, from about 4,350 to about 6,000 centipoise.

When the desired food composition is, for example, a filling, dip or spoonable dressing, the viscosity of the food composition is preferably from about 12,000 to about 120,000 centipoise, and most preferably, from about 16,000 to about 80,000 centipoise, whereby the viscosity of the food product is measured on a Haake Rheometer (Rotovisco RV20) at room temperature using a set of concentric cylinders (or bob-in-cup) with a 1 mm gap, the bob having a diameter of 1.0 cm and length of 1.0 cm. The inner cylinder or bob starts rotating from 0 shear and ramps up to a shear rate of 134 sec⁻¹ in 542 sec. By way of comparison, the viscosity values refer to the shear rate of 10 sec⁻¹.

In an especially preferred embodiment, humectant, salt, acidulant and preservatives are selected in order to produce a food composition with an A_{w} of less than about 0.96, and preferably, less than about 0.94, and most preferably, less than about 0.93.

The packaging for the food composition of this invention is often a glass jar, plastic cup or tub, food grade sachet or squeezable plastic bottle. Sachets are preferred for food service applications, and a plastic bottle is preferred for domestic use.

The examples which follow are provided to facilitate an understanding of the present invention. The examples are not intended to limit the scope of the claims.

### EXAMPLE 1

Commercially available (mayonnaise-based) gourmet chicken salad was purchased, prepackaged, from a well-known northeastern supermarket. The salad was freshly made prior to sale and contained approximately 56.0% by weight water. The salad was deplete of humectant, and did not comprise the salt combination as described in this invention.

The commercially available salad was subjected to a 5° C. closed shelf life storage study. After about 26 days, the lactic acid bacteria count was about 64,000 colony forming units per gram, the yeast count was about 400,000 colony forming units per gram, and the psychrophilic plate count (at 22° C.) was about 2,100,000 colony forming units per gram.

### EXAMPLE 2

A mayonnaise-based gourmet chicken salad substantially the same as the chicken salad described in Example 1 was made. About 4.5% by weight glycerol was added to the same along with about 0.25% by weight sodium hexametaphosphate. The resulting salad was subjected to the same 5° C. closed shelf life storage study described in Example 1. Unexpectedly, the salad comprising humectant (e.g., glycerol) and sodium hexametaphosphate, after about 28 days, had a lactic acid bacteria count of about 100 colony forming units per gram, a yeast count of about 90 colony forming units per gram, and a psychrophilic plate count (at 22° C.) of about 105 colony forming units per gram.

### EXAMPLE 3

Commercially available, thermally processed, cheese dips sold under the Frito's, Herr's and Utz brand names were purchased. The products contained about 75.0-80.0% by weight water and had A_{w} values of about 0.98. To the commercially available formulas, 1.0% by weight glycerol and 1.96% by weight sodium hexametaphosphate were added. Surprisingly, the A_{w} values were significantly reduced to about 0.958 for all products, even with such low levels of humectant.

### EXAMPLE 4

A commercially available, thermally processed, cheese sauce having a salt content of 0.9%, 51.0% by weight water and an A_{w} of 0.975 was purchased from a well-known supplier. To the commercially available formula, 0.5% glycerol was added. Surprisingly, the A_{w} value was significantly reduced to about 0.94.

1. A food composition comprising:
a) less than about 5.0% by weight humectant;
b) a stabilizing salt; and
c) water
wherein the food composition has an A_{w} of less than about 0.97 and is microbiologically stable.

2. The food composition according to claim 1 wherein the food composition comprises from about 0.25 to about 4.5% by weight humectant.

3. The food composition according to claim 1 wherein the food composition further comprises sodium chloride.

4. The food composition according to claim 3 wherein stabilizing salt plus sodium chloride does not exceed 5.5% by weight of the food composition.

5. The food composition according to claim 1 wherein the food composition is a dip, sauce, spoonable dressing, pourable dressing or filling.

6. The food composition according to claim 1 wherein the food composition has an A_{w} of less than about 0.94.

7. The food composition according to claim 1 wherein the food composition is an emulsion.

8. The food composition according to claim 5 wherein the food composition further comprises vegetable bits or particulates, bread crumbs, cheese, chicken, beef, bacon, fish or a mixture thereof.

9. The food composition according to claim 1 wherein the food composition further comprises from about 0.5% to about 75.0% by weight cheese.

10. The food composition according to claim 1 wherein the food composition comprises less than about 0.30% by weight preservative.

11. The food composition according to claim 1 wherein the food composition comprises a solid component having been pretreated in a marinating solution comprising humecant, acidulant, chelating agent, antioxidant, preservative or a mixture thereof.

12. A method for making a microbiologically stable food composition having an A_{w} of less than about 0.97 comprising, in no particular order, the steps of:
a) adding less than about 5.0% by weight humectant to a vessel;
b) adding stabilizing salt to the vessel; and
c) adding water to the vessel.
